(19) United States
(12) Patent Application Publication
(10) Pub. No.: US 2018/0094171 A1
(43) Pub. Date: Apr. 5, 2018

(54) HIGH THERMALLY CONDUCTIVE LOW PRESSURE MOULDABLE HOTMELT

(71) Applicants: HENKEL AG & CO. KGAA, Duesseldorf (DE); HENKEL IP & HOLDING GMBH, Duesseldorf (DE)

(72) Inventors: David BRIERS, Brussels (BE); Gunther Dreezen, Balen (BE); Jianfen Cai, San Marino, CA (US); Callum Poole, Corona, CA (US); Anthony Chapman, Surfside, CA (US); Dale R. Starkey, Irvine, CA (US)

(21) Appl. No.: 15/830,152

(22) Filed: Dec. 4, 2017

Related U.S. Application Data
(63) Continuation of application No. PCT/EP2016/062972, filed on Jun. 8, 2016.
(60) Provisional application No. 62/172,515, filed on Jun. 8, 2015.

(51) Int. Cl. C09J 11/04; C09J 177/00; B29C 70/70; B29C 70/88; B29C 35/16

(52) U.S. Cl. CPC C09J 11/04; C09J 177/00; C08K 7/18; B29C 70/882; B29C 35/16; B29C 70/70

(57) ABSTRACT

The present invention relates to hotmelt adhesives with improved thermal conductivity, uses thereof. The adhesive composition of the present invention comprise at least one (co)polymer binder and at least one filler, as defined herein. The thermally conductive hotmelt adhesive composition according to the present invention is also intended to encapsulate heat generating devices such as printed circuit boards to provide better heat dissipation.

### TECHNICAL FIELD OF THE INVENTION

The present invention relates to thermally conductive hotmelt adhesives, with improved thermal conductivity, uses thereof and methods for the encapsulating heat generating devices by using said thermally conductive hotmelt adhesive compositions.

### BACKGROUND OF THE INVENTION

Adhesives, which are thermally conductive are employed in several applications where a component has to be fixed upon a structure and where heat has to be deflected from the component. Many applications are therefore in the electronic components in heat exchangers, mainly encapsulates to encapsulate heat generating devices.

Materials used in conjunction with electronic applications face challenges, mainly due their poor thermal properties, too high viscosity or poor filler stability. Material having too high viscosity is not suitable for low-pressure moulding, which is preferred moulding method for electronic components. Low pressure moulding is preferred because it causes less damage to the electronic components. Material with high viscosity may have issues with filler settling. In addition, when viscosity of the composition increases, the flowability of the composition decreases at given temperature, and pressure slows down the process.

The current process to encapsulate the heat generating devices widely uses liquid thermoset materials containing fillers in a certain percentage to enable the required thermal conductivity. The current process involves mixing liquid thermoset materials and fillers together followed by potting into the package. The potting step often done under vacuum to ensure sufficient degassing to avoid voids. To finish the process, a cure schedule has to be done to harden the liquid into a thermally conductive thermoset. Such a cure schedule can take up to several hours ranging from 0.5 hours up to five or more hours.

Alternatively, one component materials have also been developed to eliminate the mixing step from the above process. However, such materials usually need cold storage as well as a vacuum and a prolonged curing process.

An attempt to meet these challenges in the past has been to provide thermally conductive adhesive compositions changes in the resin and filler materials. For example polyamides and polyurethanes have been used in the combination with various thermally conductive filler materials.

However, there is still a need in the art for adhesive hotmelt compositions that exhibit excellent thermal conductivity, while the negative effects on viscosity, filler stability and mechanical properties are minimized. While the composition would also provide the possibility for a fast and clean, high volume process to encapsulate electronic parts with a heat dissipating layer.

### SUMMARY OF THE INVENTION

The present invention relates to a thermally conductive hotmelt adhesive composition comprising: a) at least one thermally conductive filler, wherein said at least one thermally conductive filler contains a mixture of flake particles and first spherical particles in a ratio of 10:1, and wherein said flake particles have an aspect ratio of 1.25 to 7, or said at least one thermally conductive filler contains a mixture of second spherical particles having an average particle size from 35-55 μm and third spherical particles having an average particle size from 2-15 μm in a ratio of 10:1, and wherein said at least one thermally conductive filler is selected from the group consisting of tin oxide, indium oxide, antimony oxide, aluminum oxide, titanium oxide, iron oxide, magnesium oxide, zinc oxide, oxides of rare earth metals; alkaline and alkaline earth metal sulphates; chalk; boron nitride; alkaline silicate, silica, iron, copper, aluminum, zinc, gold, silver and tin, alkaline and alkaline earth metal halides; alkaline and alkaline earth metal phosphates; and mixtures thereof; and b) at least one (co)polymer selected from the group consisting of polyamides, thermoplastic polyamides, copolyamides, butyl rubber, polybutene, poly(meth)acrylates, polystyrene, polyurethanes, thermoplastic polyurethane, polyesters, ethylene copolymers, ethylene vinyl copolymers, styrene-butadiene (SB), styrene-ethylene-butadiene-styrene (SEBS), styrene-isoprene (SI), styrene-isoprene-styrene (SIS), styrene-butadiene-styrene (SBS), styrene-isoprene-butadiene (SIB), styrene-isoprene-butadiene-styrene (SIBS), polylactic acid (PLA), silicones, epoxies, polyols and mixtures thereof.

The present invention also relates to a method of encapsulating a heat generating device comprising steps of: a) applying the thermally conductive hotmelt adhesive composition according to the to the surface of said heat generating device by low pressure moulding; b) cooling; and c) removing from the mould.

In addition the present invention relates to use of the thermally conductive hotmelt adhesive composition according to the present invention in pipes, preferably cooling coils; in electronic components, preferably in light emitting devices, computer devices, mobile phones, tablets, touch screens, automotive technology hifi systems, and audio systems; in joints between heat pipes and water tanks in solar heated heating; in fuel cells and wind turbines; in the manufacture of computer chips; in light devices; batteries; in housings; coolers; heat exchanging devices; wires; cables; heating wires; refrigerators; dishwashers; air conditionings; accumulators; transformers; lasers; functional clothing; car seats; medical devices; fire protection; electric motors; planes; and trains; as a filament in 3D printing material.

The present invention also encompasses use of the thermally conductive hotmelt adhesive composition according to the present invention as a potting or moulded encapsulant for encapsulating heat generating devices

### DETAILED DESCRIPTION OF THE INVENTION

In the following passages the present invention is described in more detail. Each aspect so described may be combined with any other aspect or aspects unless clearly indicated to the contrary. In particular any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps.

The recitation of numerical end points includes all numbers and fractions subsumed within the respective ranges, as well as the recited end points.

When an amount, a concentration or other values or parameters is/are expressed in form of a range, a preferable range, or a preferable upper limit value and a preferable lower limit value, it should be understood as that any ranges obtained by combining any upper limit or preferable value with any lower limit or preferable value are specifically disclosed, without considering whether the obtained ranges are clearly mentioned in the context.

All references cited in the present specification are hereby incorporated by reference in their entirety.

Unless otherwise defined, all terms used in the disclosing the invention, including technical and scientific terms, have the meaning as commonly understood by one of the ordinary skill in the art to which this invention belongs to. By means of further guidance, term definitions are included to better appreciate the teaching of the present invention.

If reference is made herein to a molecular weight of a polymer, this reference refers to the average number molecular weight Mₙ, if not explicitly stated otherwise. The number average molecular weight Mₙ of a polymer can, for example, be determined by gel permeation chromatography according to DIN 55672-1:2007-08 with THF as the eluent. If not stated otherwise, all given molecular weights are those determined by GPC, calibrated with polystyrene standards. The weight average molecular weight M_{w} can also be determined by GPC, as described for Mₙ.

“Aspect ratio” as employed herein refers to an average aspect ratio of 50, preferably 100, particles of the respective filler as measured in accordance with the measurement method described below.

The present invention is based on the inventor's surprising finding that incorporation of a combination of different shaped thermally conductive filler materials, more particularly mixture of first spherical filler material and flake filler material or mixture of second spherical filler material and third spherical filler material, into a hotmelt adhesive composition can on the one hand provide for a synergistic increase in thermal conductivity, while maintaining desirable values for viscosity and retaining adhesive and mechanical properties without filler settling.

The adhesive compositions described herein are suitable as a thermally conductive hotmelt adhesive composition by virtue of the specific filler combination used.

Thermally conductive hotmelt adhesive according to the present invention needs to have adhesive strength high enough for bonding two substrates, such as metals and unpolar polymers or metals and metals. Adhesives need also to provide mechanical resistance. In addition, adhesives need to have the desired high thermal conductivity to allow efficient heat transfer. Furthermore, the viscosity of the hotmelt adhesive composition according to the present invention must be on desired level in order it to be suitable for low pressure moulding.

The hotmelt adhesive according to the present invention provides the possibility for a fast and clean, high volume process to encapsulate electronic parts with a heat dissipating layer. The hotmelt adhesive according to the present invention is an alternative for current thermally conductive, thermoset potting materials.

The adhesive hotmelt compositions according to the present invention therefore have to include adhesive agents that meet the above adhesive requirements, and at the same time materials that provide the improved thermal conductivity.

The present invention provides a thermally conductive hotmelt adhesive composition comprising: a) at least one thermally conductive filler, wherein said at least one thermally conductive filler contains a mixture of flake particles and first spherical particles in a ratio of 10:1, and wherein said flake particles have an aspect ratio of 1.25 to 7, or said at least one thermally conductive filler contains a mixture of second spherical particles having an average particle size from 35-55 μm and third spherical particles having an average particle size from 2-15 μm in a ratio of 10:1, and wherein said at least one thermally conductive filler is selected from the group consisting of tin oxide, indium oxide, antimony oxide, aluminum oxide, titanium oxide, iron oxide, magnesium oxide, zinc oxide, oxides of rare earth metals; alkaline and alkaline earth metal sulphates; chalk; boron nitride; alkaline silicate, silica, iron, copper, aluminum, zinc, gold, silver and tin, alkaline and alkaline earth metal halides; alkaline and alkaline earth metal phosphates; and mixtures thereof; and b) at least one (co)polymer selected from the group consisting of polyamides, thermoplastic polyamides, copolyamides, butyl rubber, polybutene, poly(meth)acrylates, polystyrene, polyurethanes, thermoplastic polyurethane, polyesters, ethylene copolymers, ethylene vinyl copolymers, styrene-butadiene (SB), styrene-ethylene-butadiene-styrene (SEBS), styrene-isoprene (SI), styrene-isoprene-styrene (SIS), styrene-butadiene-styrene (SBS), styrene-isoprene-butadiene (SIB), styrene-isoprene-butadiene-styrene (SIBS), polylactic acid (PLA), silicones, epoxies, polyols and mixtures thereof.

The compositions according to the present invention comprises at least one thermally conductive filler. Suitable thermally conductive filler is selected from the group consisting of tin oxide, indium oxide, antimony oxide, aluminum oxide, titanium oxide, iron oxide, magnesium oxide, zinc oxide, oxides of rare earth metals; alkaline and alkaline earth metal sulphates; chalk; boron nitride; alkaline silicate, silica, iron, copper, aluminum, zinc, gold, silver and tin, alkaline and alkaline earth metal halides; alkaline and alkaline earth metal phosphates; and mixtures thereof. Preferably, said thermally conductive filler is boron nitride or aluminum oxide, more preferably said thermally conductive filler is aluminum oxide.

Suitable thermally conductive filler for use in the present invention contains a mixture of flake particles and first spherical particles or a mixture of second spherical particles and third spherical particles. A mixtures of flake particles and spherical particles or a mixture of second spherical particles and third spherical particles are preferred, because the mixture provides ideal packing density, resulting in low viscosity adhesive hotmelt composition having a high thermal conductivity. Relative low viscosity adhesive hotmelt composition is preferred for the low pressure moulding. Also the mixture of flake particles and first spherical particles reduce the costs of the adhesive hotmelt composition.

Suitable thermally conductive filler for use in the present invention contains a mixture of flake particles and first spherical particles in a ratio of 10:1, preferably from 4.5:1 to 6.5:1, and preferably from 5:1 to 6:1.

Alternatively, suitable thermally Conductive filler for use in the present invention contains a mixture of second spherical particles and third spherical particles in a ratio of 10:1, preferably from 4.5:1 to 6.5:1, and preferably from 5:1 to 6:1.

If the ratio is too high, for example 25:1 or 1:25, the packing density may be insufficient to provide the needed thermal conductivity. Such a high ratio may also increase the viscosity of the composition too high.

Suitable flake particles for use in the present invention have an aspect ratio from 1.25 to 7, preferably from 1.5 to 5, more preferably from 1.75 to 4 and most preferably from 2 to 3.

If the aspect ratio is above 7, it becomes more difficult to uniformly disperse the particles in the (co)polymer. Even though such particles may provide desired thermal conductivity, it may be difficult to achieve a uniformly dispersed mixture at the threshold volume concentration needed for bulk, thermal conductivity.

“Aspect ratio”, as used herein, relates to the ratio between sizes in different dimensions of a three-dimensional object, more particularly the ratio of the longest side to the shortest side, for example height to width. Ball-shaped or spherical particles therefore have an aspect ratio of about 1, while fibres, needles or flakes have aspect ratio of more than 1, as they have in relation to their length or length and width a comparable small diameter or thickness. The aspect ratio can be determined by scanning electron microscopy (SEM) measurements. As the software, “Analysis pro” from Olympus Soft Imaging Solutions GmbH can be used. The magnification is between x250 to x1000 and the aspect ratio is a mean value obtained by measuring the width and the length of at least 50, preferably 100 particles in the picture. In case of relatively big and flaky fillers, the SEM measurements can be obtained with a tilt angle of 45° of the sample.

Suitable flake particles for use in the present invention have an average particle size (d₅₀) from 30 to 60 μm, preferably from 35 to 50 μm, and more preferably from 42 to 47 μm and most preferably from 44 to 46 μm. The particle size can, for example, be determined by laser diffraction method according to ISO 13320:2009.

Suitable spherical particles for use in the present invention have aspect ratio of 1. The aspect ratio is measured according to the test method described above.

Suitable first spherical particles for use in the present invention have an average particle size (d₅₀) from 3 to 50 μm, preferably from 4 to 48 μm, and more preferably from 5 to 45 μm. The particle size can, for example, be determined by laser diffraction method according to ISO 13320:2009.

Suitable second spherical particles for use in the present invention have an average particle size (d₅₀) from 40 to 50 μm, and preferably from 42 to 48 μm. The particle size can, for example, be determined by laser diffraction method according to ISO 13320:2009.

Suitable third spherical particles for use in the present invention have an average particle size (d₅₀) from 2 to 10 μm, preferably from 3 to 8 μm, and more preferably from 4 to 6 μm. The particle size can, for example, be determined by laser diffraction method according to ISO 13320:2009.

For a given volume percentage of the filler, if the particle size is too small, the surface area of particles will increase too high, which will result in composition having too high viscosity. Whereas, too large particle size may make low pressure moulding impossible. For low pressure moulding, the nozzle orifice (opening to the mould) has a certain diameter, which will have an effect on the maximum particle size, which can be used in the composition.

A thermally conductive hotmelt adhesive composition according to the present invention comprises a thermally conductive filler from 50 to 80% by weight of the total weight of the composition, preferably from 60 to 80%. If the quantity of the thermally conductive filler is above 80%, the viscosity of the hotmelt adhesive becomes too high to mould. On the other hand, if the quantity of the thermally conductive filler is less 50%, the thermal conductivity of the adhesive composition is too low.

In one preferred embodiment, the thermally conductive filler is aluminium oxide, mixture of flake aluminium oxide particles and first spherical aluminium oxide particles in a ratio of 10:1. In this embodiment the flake shape filler particle has an aspect ratio from 1.25 to 7 and an average particle size (d₅₀) from 30 to 60 μm, whereas, the spherical filler particle has an aspect ratio of 1 and an average particle size (d₅₀) from 3 to 50 μm.

In one preferred embodiment, the thermally conductive filler is aluminium oxide, mixture of flake aluminium oxide particles and first spherical aluminium oxide particles in a ratio of 10:1. In this embodiment the flake shape filler particle has an aspect ratio from 1.5 to 5 and an average particle size (d₅₀) from 30 to 60 μm, whereas, the spherical filler particle has an aspect ratio of 1 and an average particle size (d₅₀) from 3 to 50 μm.

In another preferred embodiment, the thermally conductive filler is aluminium oxide, mixture of flake aluminium oxide particles and first spherical aluminium oxide particles in a ratio from 4.5:1 to 6.5:1. In this embodiment the flake shape filler particle has an aspect ratio from 1.75 to 4 and an average particle size (d₅₀) from 35 to 50 μm, whereas, the spherical filler particle has an aspect ratio of 1 and an average particle size (d₅₀) from 4 to 48 μm.

Yet in another preferred embodiment, the thermally conductive filler is aluminium oxide, mixture of flake aluminium oxide particles and first spherical aluminium oxide particles in a ratio from 5:1 to 6:1. In this embodiment the flake shape filler particle has an aspect ratio from 2 to 3 and an average particle size (d₅₀) from 42 to 47 μm, whereas, the spherical filler particle has an aspect ratio of 1 and an average particle size (d₅₀) from 5 to 45 μm.

Yet in another preferred embodiment, the thermally conductive filler is aluminium oxide, mixture of flake aluminium oxide particles and first spherical aluminium oxide particles in a ratio from 5:1 to 6:1. In this embodiment the flake shape filler particle has an aspect ratio from 2 to 3 and an average particle size (d₅₀) from 44 to 46 μm μm, whereas, the spherical filler particle has an aspect ratio of 1 and an average particle size (d₅₀) from 5 to 45 μm.

In one preferred embodiment, the thermally conductive filler is aluminium oxide, mixture of second spherical aluminium oxide particles and third spherical aluminium oxide particles in a ratio of 10:1. In this embodiment the second spherical filler has an average particle size (d₅₀) from 35 to 55 μm, whereas, third spherical filler particle has an average particle size (d₅₀) from 2 to 15 μm.

In another preferred embodiment, the thermally conductive filler is aluminium oxide, mixture of second spherical aluminium oxide particles and third spherical aluminium oxide particles in a ratio from 4.5:1 to 6.5:1. In this embodiment second spherical filler particle has an average particle size (d₅₀) from 40 to 50 μm, whereas, third spherical filler particle has an average particle size (d₅₀) from 2 to 10 μm.

Yet in another preferred embodiment, the thermally conductive filler is aluminium oxide, mixture of second spherical aluminium oxide particles and third spherical aluminium oxide particles in a ratio from 5:1 to 6:1. In this embodiment second spherical filler particle has an average particle size (d₅₀) from 42 to 48 μm, whereas, third spherical filler has an average particle size (d₅₀) from 3 to 8 μm.

Yet in another preferred embodiment, the thermally conductive filler is aluminium oxide, mixture of second spherical aluminium oxide particles and third spherical aluminium oxide particles in a ratio from 5:1 to 6:1. In this embodiment second spherical filler particle has an average particle size (d₅₀) from 42 to 48 μm, whereas, third spherical filler has an average particle size (d₅₀) from 4 to 6 μm.

A thermally conductive hotmelt adhesive composition according to the present invention comprises a (co)polymer as binding agent. The term (co)polymer includes homopolymers, copolymers, block copolymers and terpolymers.

In particular suitable for use in the present invention are elastomeric (co)polymers, more preferably elastomeric thermoplastic (co)polymers. Exemplary (co)polymers that are suitable as components of the binder matrix of the compositions according to the present invention include, polyamides, preferably thermoplastic polyamides, polyolefins, preferably alpha-olefins, more preferably butyl rubber or polybutene, poly(meth)acrylates, polystyrene, polyurethanes, preferably thermoplastic polyurethane, polyesters, ethylene copolymers, ethylene vinyl copolymers, styrenic block copolymers, preferably styrene-butadiene (SB), styrene-ethylene-butadiene-styrene (SEBS), styrene-isoprene (SI), styrene-isoprene-styrene (SIS), styrene-butadiene-styrene (SBS), styrene-isoprene-butadiene (SIB), or styrene-isoprene-butadiene-styrene (SIBS), polylactic acid (PLA), copolyamides, silicones, epoxies, polyols or combinations thereof.

Preferably, (co)polymers are selected from the group consisting of polyamide, thermoplastic polyamide or copolyamide, preferably polyamide or thermoplastic polyamide. These (co)polymers are preferred because they are non-toxic and safer to use compared to typical potting solutions, which contain for example amines (amine/epoxy thermosets) or isocyanates (polyurethane thermosets).

A thermally conductive hotmelt adhesive composition according to the present invention may further comprise one or more additional additives, preferably selected from the group consisting of plasticizers, dyes, waxes, antioxidants, surfactants, stabilizers, rheology modifiers, cross-linking agents, and combinations thereof.

A thermally conductive hotmelt adhesive composition according to the present invention may further comprise waxes. Exemplary waxes that can be used include, without limitation, polar waxes selected from functionalized polyolefins with a molecular weight M_{N} range as determined by GPC between about 4000 and 80000 and based on ethylene and/or propylene with acrylic acid, methacrylic acid, C1-4 alkyl esters of (meth)acrylic acid, itaconic acid, fumaric acid, vinyl acetate, carbon monoxide, and in particular maleic acid and mixtures thereof. Preferred are ethylene, propylene or ethylene-propylene (co)polymers grafted or copolymerized with polar monomers with saponification and acid values, respectively, between 2 and 50 mg KOH/g. Saponification and acid values can be determined by titration.

The rheology of the composition according to the present invention and/or the mechanical properties of the glue joint can be adjusted by the addition of so-called extender oils, i.e. aliphatic, aromatic or naphthenic oils, low molecular weight polybutenes or polyisobutylenes. Additionally poly-alpha-olefins which are liquid at 25° C. can be employed which are commercially available for example under the tradename Synfluid PAO. Also conventional plasticizers, such as dialkyl or alkylaryl esters of phthalic acid or dialkyl esters of aliphatic dicarboxylic acids can be used, optionally in admixture with the afore-mentioned extender oils.

A thermally conductive hotmelt adhesive composition according to the present invention may comprise a plasticizer or an extender oil from 0 to 10% of by weight of the total weight of the composition.

Suitable stabilizers that can be used in the compositions according to the present invention include, without limitation, 2-(hydroxyphenyl)-benzotriazole, 2-hydroxybenzophenone, alkyl-2-cyano-3-phenylcinnamate, phenylsalicylate or 1,3,5-tris(2′-hydroxyphenyl)triazine. Suitable antioxidants include, without limitation, those commercially available under the trademark name Irganox® (BASF, SE). Also suitable are distearyl-pentaerythritdiphosphate compounds, octadecyl esters of 3,5-bis(1,1-dimethylethyl)-4-hydroxybenzylpropanoic acid (Irganox® 1076), 2,4-bis(n-octylthio)-6-(4-hydroxy-3,5-di-tert-butylanilino)-1,3,5-triazine (Irganox® 565), 2-tert-butyl-6-(3-tert-butyl-2-hydroxy-5-methylbenzyl)-4-methylphenylacrylate, phosphite antioxidants, such as tris(nonylphenyl)phosphite (TNPP), tris(mono-nonylphenyl)phosphite, and tris(di-nonylphenyl)phosphite, bis(2,4-di-tert-butylphenyl)pentaerythrit diphosphate, tris(2,4-di-tert-butylphenyl)phosphite and combinations or 2 or more of the afore-mentioned compounds.

A thermally conductive hotmelt adhesive composition according to the present invention may comprise a stabilizer from 0 to 5% of by weight of the total weight of the composition.

A thermally conductive hotmelt adhesive composition according to the present invention have a thermal conductivity of at least 0.500 W/(m*K), preferably at least 0.700 W/(m*K), more preferably at least 0.750 W/(m*K), most preferably at least 0.800 W/(m*K). The thermal conductivity can be determined by using Holometric's laser flash according to ASTM1461.

In various embodiments, while having a high thermal conductivity, the adhesive compositions still retain a viscosity that allows simple application on to the substrate. The viscosity of the thermally conductive hotmelt adhesive according to the present invention is meant viscosity in the molten state. More particularly, in preferred embodiments, the viscosity of the adhesive composition is from 500 to 50,000 mPas, preferably from 5,000 to 25,000 mPas, more preferably from 5,000 to 15,000 mPas. The viscosity can be determined according to ASTM D 3236, except that the temperature was 210° C. or 240° C. instead of 175° C.

Low viscosity enables a low pressure moulding, meaning that the moulding can be done between 2 and 30 bar. This leads to the use of aluminium moulds instead of steel moulds, which decrease the price of the process. In addition, low pressure allows faster cycle times on production (10-50 seconds). Lower pressure also increase the productivity of the process, because it allows higher output compared to liquid, thermoset potting solutions (reduced number of process steps). Lower pressure also causes less damage to the electronic components.

A thermally conductive hotmelt adhesive composition according to the present invention can be produced by conventional means. Preferred methods include the manufacture by mixers, for example planetary mixer, planetary dissolver, kneader, internal mixer and extruder.

Generally, a thermally conductive hotmelt adhesive composition according to the present invention can be produced by melting first the (co)polymer and optionally additive(s) and then mixing until a homogenous mixture is obtain. Subsequently, the filler particles are added into the mixture in any order. The final composition is then thoroughly mixed and allowed to cool to a room temperature.

The thermally conductive hotmelt adhesive composition according to the present invention is intended to encapsulate heat generating devices, such as printed circuit boards to provide better heat dissipation. The encapsulates can be prepared via low pressure moulding.

Accordingly, the invention is directed to a method of encapsulating a heat generating device comprising steps of:
a) applying by using injection moulding the thermally conductive hotmelt adhesive composition according to the present invention to the surface of said heat generating device by low pressure moulding;
b) cooling; and
c) removing from the mould.

Preferably, the liquefied thermally conductive hotmelt adhesive composition is injected at temperature of 210° C. and under low pressure.

The thermally conductive hotmelt adhesive composition according to the present invention can be applied using low pressure injection moulding instead of the typical potting process. Low pressure can be used, between 2 and 30 bar. The hotmelt adhesive according to the present invention also enables fast curing cycle times from 10 to 50 seconds instead of prolonged curing cycles. In addition the hotmelt adhesive according to the present invention provides clean and simple process, having no need to mix two components or perform the process under vacuum. Finally, the process according to the present invention requires less energy, because the heat curing step has been eliminated.

The thermally conductive hotmelt adhesive composition according to the present invention can also be used in the gluing of components of the electronic devices together e.g. circuit boards, electronic components, sensors and control systems.

The present invention also covers method for bonding two substrates and for producing an article of manufacture by bonding two substrates. In these methods, the thermally conductive hotmelt adhesive composition according to the present invention is applied in molten state onto the substrate surface, for example by a roll coating or by bead application. The substrate surface with the adhesive is then pressed onto the other substrate to be bonded. The substrate may include metal plates.

A thermally conductive hotmelt adhesive composition according to the present invention may therefore be used to bond metal plating to a plastic or metal substrate. In these applications the thermal conductivity of the adhesive is of particular importance.

Accordingly, the invention is directed to a method of manufacturing an article comprising at least two bonded substrates, comprising steps of:
a) applying the thermally conductive hotmelt adhesive composition according to the present invention to the surface of a first substrate to be bonded; and
b) bringing the surface of the first substrate to be bonded comprising the thermally conductive hotmelt adhesive composition into contact with a second substrate to be bonded.

Depending on the number of substrates to be bonded, steps (a) and (b) may be repeated to bond a third or further substrate to the already bonded substrates. Therefore, the method would comprise further step (c) optionally repeating steps (a) and (b) with a third or further substrate to be bonded.

Also encompassed by the present invention are the articles of manufacture that are obtainable according to the methods described herein and that include the adhesives described herein.

The adhesive compositions described herein can be used in various fields, the manufacture of electronic devices. More specifically, they can be used in the manufacturing and bonding of pipes, preferably cooling coils; electronic components, preferably in light emitting devices, computer devices, mobile phones, tablets, touch screens, and audio systems; automotive technology; in joints between heat pipes and water tanks in solar heated heating; in fuel cells and wind turbines; in the manufacture of computer chips; in light devices; batteries; in housings; coolers; heat exchanging devices; wires, such as heating wires; cables; refrigerators; dishwashers; air conditionings; accumulators; transformers; lasers; functional clothing; car seats; medical devices; fire protection; electric motors; planes; and trains; and as a filament in 3D printing material.

In highly preferred embodiment, the thermally conductive hotmelt adhesive composition according to the present invention can be used as a potting or moulded encapsulant to encapsulate heat generating devices such as printed circuit boards to provide improved heat dissipation.

The invention is further illustrated by the following examples. It is however understood that these examples are for purpose of illustration only and not to be construed as limiting the invention.

### EXAMPLES

### Examples E1 to E3 and Comparative Examples V1 to V4

Different adhesive compositions were prepared with their compositions shown in Table 1.

To obtain the compositions, first the (co)polymer and optionally additive(s) were heated until the (co)polymer is molten and then mixed until a homogenous phase is obtain. To this phase, the fillers are subsequently given in any order. The final composition is then thoroughly mixed and allowed to cool to room temperature.

TABLE 1
Adhesive compositions

| | Compound | | | | | | | |
|---|---|---|---|---|---|---|---|---|
| formulation | V0 | V1 | V2 | V3 | V4 | E1 | E2 | E3 |
| Polyamide 1 | | 100 | 60 | 60 | 40 | | 40 | |
| Polyamide 2 | 100 | | | | | 20 | | 30 |
| Spherical | | | | | 60 | | | |
| alumina 1 (d50 = | | | | | | | | |
| 12 μm) | | | | | | | | |
| Tabular Alumina | | | | | | | | 59.5 |
| (aspect ratio = | | | | | | | | |
| 1.5) | | | | | | | | |
| Spherical | | | 6 | | | 12 | 9 | 10.5 |
| alumina 2 (d50 = | | | | | | | | |
| 5 μm) | | | | | | | | |
| Spherical | | | | 40 | | | | |
| alumina 3 (d50 = | | | | | | | | |
| 10 μm) | | | | | | | | |
| Spherical | | | 34 | | | 68 | 51 | |
| alumina 4 (d50 = | | | | | | | | |
| 45 μm) | | | | | | | | |

Polyamide 1 is Technomelt OM673 from Henkel; Spherical alumina 1 is DAW/DAM-12 from Denka; Spherical alumina 2 is DAW/DAM-05 from Denka; Spherical alumina 3 is DAW/DAM-50 from Denka; Spherical alumina 4 is DAW/DAM-45 from Denka; Tabular alumina is Tabular alumina T60/T64 from Almatis.

The adhesive formulations were then tested with respect to their thermal conductivity and viscosity. The measurements have been made according to the test methods described above. The viscosity has been measured at 210° C. The results are shown in Table 2.

TABLE 2
Thermal conductivity and viscosity measurements

| formu- | Compound | | | | | | | |
|---|---|---|---|---|---|---|---|---|
| lation | V0 | V1 | V2 | V3 | V4 | E1 | E2 | E3 |
| Viscosity | 1500 | 3400 | 4050 | 4275 | 9189 | 14000 | 7450 | 14400 |
| @ | | | | | | | | |
| 210° C. | | | | | | | | |
| (mPa · s) | | | | | | | | |
| Thermal | 0.15 | 0.15 | 0.44 | 0.35 | 0.52 | 1.48 | 0.56 | 0.92 |
| conduc- | | | | | | | | |
| tivity | | | | | | | | |
| (W/m · K) | | | | | | | | |

It can be seen from the examples and comparative examples that a significantly improved thermal conductivity can be obtained by compositions according to the present invention.

1: A thermally conductive hotmelt adhesive composition comprising:
a) at least one thermally conductive filler, wherein
said at least one thermally conductive filler contains a mixture of flake particles and first spherical particles in a ratio of 10:1, and wherein said flake particles have an aspect ratio of 1.25 to 7, or
said at least one thermally conductive filler contains a mixture of second spherical particles having an average particle size from 35-55 μm and a third spherical particles having an average particle size from 2-15 μm in a ratio of 10:1, and
wherein
said at least one thermally conductive filler is selected from the group consisting of tin oxide, indium oxide, antimony oxide, aluminum oxide, titanium oxide, iron oxide, magnesium oxide, zinc oxide, oxides of rare earth metals; alkaline and alkaline earth metal sulphates; chalk; boron nitride; alkaline silicate, silica, iron, copper, aluminum, zinc, gold, silver and tin, alkaline and alkaline earth metal halides; alkaline and alkaline earth metal phosphates; and mixtures thereof; and
b) at least one (co)polymer selected from the group consisting of polyamides, thermoplastic polyamides, copolyamides, butyl rubber, polybutene, poly(meth)acrylates, polystyrene, polyurethanes, thermoplastic polyurethane, polyesters, ethylene copolymers, ethylene vinyl copolymers, styrene-butadiene (SB), styrene-ethylene-butadiene-styrene (SEBS), styrene-isoprene (SI), styrene-isoprene-styrene (SIS), styrene-butadiene-styrene (SBS), styrene-isoprene-butadiene (SIB), styrene-isoprene-butadiene-styrene (SIBS), polylactic acid (PLA), silicones, epoxies, polyols and mixtures thereof.

2: The thermally conductive hotmelt adhesive composition according to claim 1, wherein sad flake particles have an aspect ratio from 1.5 to 5.

3: The thermally conductive hotmelt adhesive composition according to claim 1, wherein said flake particles have an average particle size (d₅₀) from 30 to 60 μm.

4: The thermally conductive hotmelt adhesive composition according to claim 1, wherein said first spherical particles have an average particle size (d₅₀) from 3 to 50 μm.

5: The thermally conductive hotmelt adhesive composition according to claim 1, wherein ratio of flake particles to first spherical particles or ratio of second spherical particles to third spherical particles is from 4.5:1 to 6.5:1, preferably from 5:1 to 6:1.

6: The thermally conductive hotmelt adhesive composition according to claim 1, wherein said second spherical particles have an average particle size (d₅₀) from 40 to 50 μm.

7: The thermally conductive hotmelt adhesive composition according to claim 1, wherein said third spherical particles have an average particle size (d₅₀) from 2 to 10 μm.

8: The thermally conductive hotmelt adhesive composition according to claim 1, wherein said at least one thermally conductive filler is boron nitride or aluminum oxide.

9: The thermally conductive hotmelt adhesive composition according to claim 1, wherein said at least one at least one (co)polymer is polyamide, thermoplastic polyamide or copolyamide.

10: The thermally conductive hotmelt adhesive composition according to claim 1, wherein said composition comprises a thermally conductive filler from 50 to 80% by weight of the total weight of the composition.

11: The thermally conductive hotmelt adhesive composition according to claim 1, wherein said composition comprises a (co)polymer from 20 to 50% by weight of the total weight of the composition.

12: The thermally conductive hotmelt adhesive composition according to claim 1, wherein the viscosity of the adhesive composition is from 500 to 50,000 mPas.

13: The thermally conductive hotmelt adhesive composition according to claim 1, wherein the thermal conductivity of the adhesive composition is at least 0.500 W/(m*K).

14: A method of encapsulating a heat generating device comprising steps of:
a) applying the thermally conductive hotmelt adhesive composition according to claim 1 to the surface of said heat generating device by low pressure moulding;
b) cooling; and
c) removing from the mould.

15: (canceled)

16: (canceled)

17: An article of manufacturing a thermally conductive hotmelt adhesive composition according to claim 1.

18: The article of claim 17, which is a circuit board, electronic component, sensor or control system.
